(19) United States
(12) Patent Application Publication
(10) Pub. No.: US 2015/0113367 A1
(43) Pub. Date: Apr. 23, 2015

(54) IMAGE TRANSITIONING AND ERROR DETECTION FOR ONLINE PRESENTATIONS

(71) Applicant: International Business Machines Corporation, Armonk, NY (US)

(72) Inventors: Yuk L. Chan, Rochester, NY (US); Gisela C. Cheng, Poughkeepsie, NY (US); Kin Ng, Poughkeepsie, NY (US); Derrick L. Washington, Morrisville, NC (US)

(73) Assignee: International Business Machines Corporation, Armonk, NY (US)

(21) Appl. No.: 14/056,087

(22) Filed: Oct. 17, 2013

(51) Int. Cl. G06F 17/21

(52) U.S. Cl. CPC G06F 17/211
USPC 715/203

(57) ABSTRACT

According to an exemplary embodiment of this disclosure, a computer-implemented method includes capturing a plurality of images from a presentation. Each of the plurality of images is associated with a unique identifier. The unique identifiers are transmitted to one or more remote audience modules. The plurality of images are then transmitted to the audience modules. With a computer processor, a first image from the plurality of images is identified as a next active image. Indications are received from the one or more of the audience modules that the next active image has been received. The audience modules are instructed to update their displays from a current active image to the next active image, after the indications are received.

### BACKGROUND

Various embodiments of this disclosure relate to online presentations and, more particularly, to systems and methods for facilitating transitions and error-detection during online presentations.

Online conferencing is an integral part of today's business communications and often includes sharing a presentation across a network. Rapid screen transitions can create problems in presentation sharing. For example, if a presenter's display changes multiple times in a row, such as may be the result of paging up within a document to reach a certain point, the contents of the material being passed over may be transmitted to the remote audience. In some instances, the remote audience end up viewing a page that the presenter did not intend it to view and, as a result, may be unable to follow along.

This problem is further complicated in that portions of the remote audience in separate locations from one another may be connected to the presentation via different equipment and over different networks with various network speeds. Because of this variation, some parts of the audience may receive new presentation images while other parts of the audience are still viewing old presentation images.

Online presentation errors, e.g., where some members of the audience are not seeing the correct image, are not easily detected by the remote audience or the presenter. It may take time for the presenter to learn that a problem exists, as errors may become apparent only after a remote audience member realizes he is not seeing the correct image and indicates such to the presenter.

### SUMMARY

In one embodiment of this disclosure, a computer-implemented method includes capturing a plurality of images from a presentation. Each of the plurality of images is associated with a unique identifier. The unique identifiers are transmitted to one or more remote audience modules. The plurality of images are then transmitted to the audience modules. With a computer processor, a first image from the plurality of images is identified as a next active image. Indications are received from the one or more of the audience modules that the next active image has been received. The audience modules are instructed to update their displays from a current active image to the next active image, after the indications are received.

In another embodiment, a presentation system includes an image capturer, a communication manager, and a display manager. The image capturer is configured to capture a plurality of images from a presentation and to associate each of the plurality of images with a unique identifier. The communication manager is configured to transmit to one or more remote audience modules a first identifier associated with a first image of the plurality of images, in a first transmission, and the first identifier along with the first image, in a second transmission. The display manager is configured to identify the first image as a next active image for the presentation. The communication manager is further configured to receive indications from one or more of the audience modules that the next active image has been received, and the display manager is further configured to instruct the audience modules to update their displays from a current active image to the next active image, after the communications manager receives the indications.

In yet another embodiment, a computer-implemented method includes displaying an active image as part of a presentation. A plurality of images is received over a network, each image being associated with a unique identifier. After receipt of the images, an instruction is received to update the active image, the instruction referencing a first unique identifier. A first image is selected, by a computer processor, from among the plurality of images, where the first image is identified by the first unique identifier. The first image is then displayed as the active image in the presentation in response to the instruction.

In yet another embodiment, a system includes a display manager and a communication manager. The display manager is configured to display an active image as part of a presentation. The communication manager is configured to receive, from a presenter module over a network, a plurality of images, each image being associated with a unique identifier. The communication manager is also configured to receive, after the plurality of images, an instruction to update the active image, the instruction referencing a first unique identifier. The display manager is further configured to select a first image from the plurality of images based on the first image being identified by the first identifier, and to display the first image as the active image in response to the instruction.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram of a computing device for implementing a presentation system, according to an exemplary embodiment of this disclosure;

FIG. 2 is a block diagram of a presentation system, according to an exemplary embodiment of this disclosure;

FIG. 3 is a flow diagram of a method for providing a presentation, according to an exemplary embodiment of this disclosure; and

FIG. 4 is a flow diagram of a method for receiving a presentation, according to an exemplary embodiment of this disclosure.

### DETAILED DESCRIPTION

Various embodiments of this disclosure are presentation systems and methods for facilitating page transitions and detecting errors in online presentations. As will be discussed further below, each image of the presenter's presentation display may be given a unique identifier, used to ensure its display to remote audience members. Additionally, the presenter and the remote audience may be notified when pages are not being displayed according to predetermined standards.

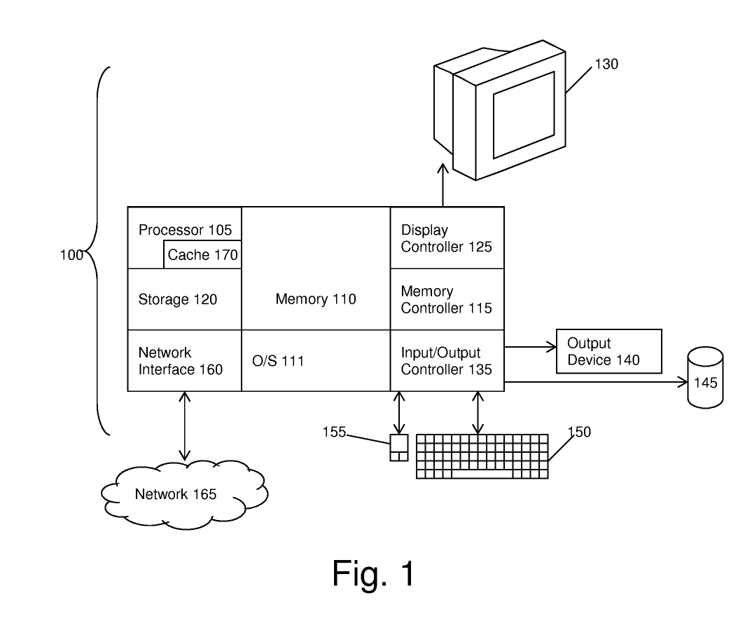

FIG. 1 illustrates a block diagram of a computer system 100 for use in implementing a presentation system or method according to some embodiments. The presentation systems and methods described herein may be implemented in hardware, software (e.g., firmware), or a combination thereof. In an exemplary embodiment, the methods described may be implemented, at least in part, in hardware and may be part of the microprocessor of a special or general-purpose computer system 100, such as a personal computer, workstation, minicomputer, or mainframe computer.

In an exemplary embodiment, as shown in FIG. 1, the computer system 100 includes a processor 105, memory 110 coupled to a memory controller 115, and one or more input and/or output (I/O) devices 140 and 145, such as peripherals, that are communicatively coupled via a local I/O controller 135. The I/O controller 135 may be, for example but not limitation, one or more buses or other wired or wireless connections, as are known in the art. The I/O controller 135 may have additional elements, which are omitted for simplicity, such as controllers, buffers (caches), drivers, repeaters, and receivers, to enable communications.

The processor 105 is a hardware device for executing hardware instructions or software, particularly those stored in memory 110. The processor 105 may be any custom made or commercially available processor, a central processing unit (CPU), an auxiliary processor among several processors associated with the computer system 100, a semiconductor based microprocessor (in the form of a microchip or chip set), a macroprocessor, or other device for executing instructions. The processor 105 includes a cache 170, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 170 may be organized as a hierarchy of more cache levels (L1, L2, etc.).

The memory 110 may include any one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, or other types of storage media. Note that the memory 110 may have a distributed architecture, where various components are situated remote from one another but may be accessed by the processor 105.

The instructions in memory 110 may include one or more separate programs, each of which comprises an ordered listing of executable instructions for implementing logical functions. In the example of FIG. 1, the instructions in the memory 110 include a suitable operating system (OS) 111. The operating system 111 essentially may control the execution of other computer programs and provides scheduling, input-output control, file and data management, memory management, and communication control and related services.

Additional data, including, for example, instructions for the processor 105 or other retrievable information, may be stored in storage 120, which may be a storage device such as a hard disk drive.

In an exemplary embodiment, a conventional keyboard 150 and mouse 155 may be coupled to the I/O controller 135. Other output devices such as the I/O devices 140 and 145 may include input devices, for example but not limited to, a printer, a scanner, a microphone, and the like. The I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like.

The computer system 100 may further include a display controller 125 coupled to a display 130. In an exemplary embodiment, the computer system 100 may further include a network interface 160 for coupling to a network 165. The network 165 may be an IP-based network for communication between the computer system 100 and any external server, client and the like via a broadband connection. The network 165 transmits and receives data between the computer system 100 and external systems. In an exemplary embodiment, the network 165 may be a managed IP network administered by a service provider. The network 165 may be implemented in a wireless fashion, e.g., using wireless protocols and technologies, such as WiFi, WiMax, etc. The network 165 may also be a packet-switched network such as a local area network, wide area network, metropolitan area network, the Internet, or other similar type of network environment. The network 165 may be a fixed wireless network, a wireless local area network (LAN), a wireless wide area network (WAN) a personal area network (PAN), a virtual private network (VPN), intranet or other suitable network system and may include equipment for receiving and transmitting signals.

Systems and methods according to this disclosure may be embodied, in whole or in part, in computer program products or in computer systems 100, such as that illustrated in FIG. 1.

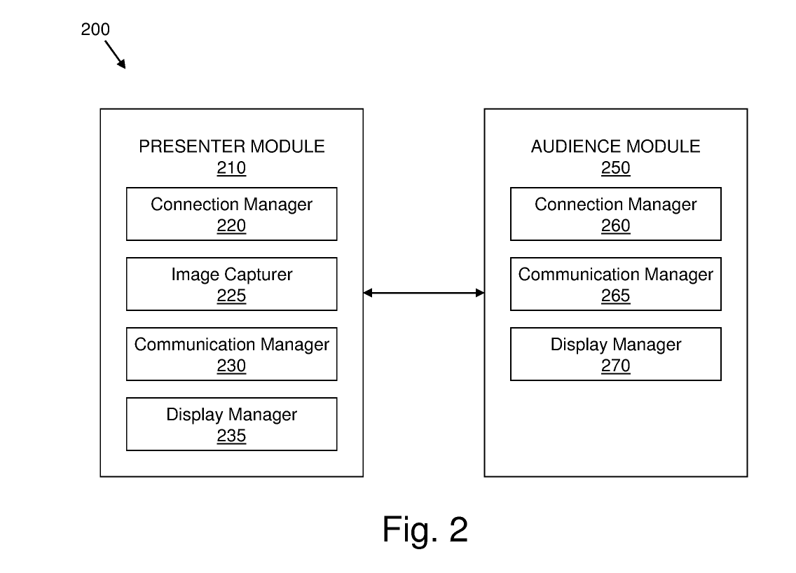

FIG. 2 is a block diagram of an exemplary presentation system 200, according to some embodiments of this disclosure. It will be understood that the various components displayed in FIG. 2 need not be distinct as shown. Rather, these components may share hardware or software, and a single component may be implemented as multiple hardware or software parts.

As shown, the presentation system 200 may include a presenter module 210 and an audience module 250. The presenter module 210 may be used by a presenter and may reside at the presenter's local computer system 100. Analogously, the audience module 250 may be used by each location of a remote audience receiving the presentation. An instance of the audience module 250 may reside at a local computer associated with each remote audience location. As a result, the presenter module 210 may communicate over a network with each of the various audience modules 250.

The presenter module 210 may include a connection manager 220, an image capturer 225, a communication manager 230, and a display manager 235.

The connection manager 220 may send periodic heartbeats to each of the connected audience modules 250. For example, and not by way of limitation, these heartbeats may be transmitted every few seconds. The heartbeats may take various forms, so long as they are some form of data being transmitted consistently to the audience modules 250 to indicate that the presenter module 210 is still in communication with them. In some embodiments, the connection manager 220 may run at a higher priority than various other aspects of the presentation system 200, such as the image capturer 225 and the display manager 235, to ensure that connections to the audience are properly managed. The connection manager 210 may, for example, run in a separate thread or over a separate network connection.

Likewise, the connection manager 220 may receive heartbeats from each of the audience modules 250. When the presentation begins, the connection manager 220 may associate each connected audience module 250 with an identifier, such as an IP address of the computer system 100 running the audience module. Each heartbeat received from an audience module 250 may be associated with that audience modules' identifier, thus enabling the presenter module 210 to keep track of which audience modules' heartbeats are being received. When an expected heartbeat is not received for a particular audience module 250, the connection manager 220 may notify the presenter that the respective audience module 250 is no longer connected. The presenter may then act accordingly, such as by contacting the remote audience at that location or by pausing the presentation.

In some embodiments, the connection manager 220 may identify the type of network over which each audience module 250 is connected to the presenter module 210. In some implementations, the audience modules 250 may explicitly specify their network types to the connection manager 220, which network types may be provided manually by the remote viewers in the audience. If this network-type data is available, the presenter module 210 may display to the presenter the various network types, and the presenter or the presenter module 210 may use this information to determine when to switch the active image, i.e., the current image for the presentation.

The image capturer 225 may capture images from the presenter's presentation display. In some embodiments, the presentation display may be the entire desktop of the presenter, but this need not be the case. In some other embodiments, the image capturer 225 may be limited to capturing a subset of the desktop, such as data that is displayed within a particular window shown on the computer system 100 with the presenter module 210.

The image capturer 225 may be implemented in various ways. For example, and not by way of limitation, the image capturer 225 may capture a new image from the presentation display at predetermined time intervals. For another example, the image capturer 225 may detect when the presentation display has changed, and may capture a new image in response to such change. Other methods for capturing or detecting new images may also be used, such as those methods already existing in the art. The image capturer 225 may associate each captured image with a unique identifier, such that no two images contain the same identifier even if two images contain the exact same content (which may be the case, for example, with periodic image capturing).

The communication manager 230 may transmit, to each instance of the audience module 250, the unique identifier of each image captured by the image capturer 225. In an exemplary embodiment, these transmissions may occur soon after the capture of the images. In other words, when a new image is captured and assigned an identifier, the communication manager 230 may then notify the audience module 250 of the existence of the new image and its associated identifier.

Separate from the initial notification of the existence of a new image, the communication manager 230 may also transmit, to each instance of the audience module 250, the new image itself along with the previously transmitted, associated identifier. The image itself may be transmitted separate from the initial notification of the image's existence to ensure that the audience modules 250 receive the notification of the image's existence even if they do not receive the image itself. Thus, the audience module 250 may receive, for each image captured at the presenter module 210, (1) a notification of the capture and the unique identifier associated with the new image and (2) the new image itself with its unique identifier.

In some embodiments, the communication manager 230 may run one or more processes for sending and receiving image notifications separate from one or more processes for sending the actual images. This separation may isolate impacts between the two sets of operations. For example, and not by way of limitation, the notifications may be handled in one or more threads, using one or more queuing buffers, or over one or more distinct network connections as compared to those used for image transmission. In such embodiments, notification handling may run at a higher priority than image transmission, such that the notifications may be processed in a timely manner with reduced effect from potential computer and network performance issues.

As shown in FIG. 2, each instance of the audience module 250 may include an audience connection manager 260, an audience communication manager 265, and a display manager 270.

The connection manager 260 of the audience module 250 may behave similarly to the presenter module's connection manager 220. It may transmit periodic heartbeats to the presenter module 210 to indicate that it is still in communication with the presenter module 210. The audience connection manager 220 may also receive the heartbeats from the presenter connection manager 220. When the heartbeats from the presenter module 210 are not received as expected, the audience module 210 may notify the local audience that it has been disconnected from the presentation.

The communication manager 265 may both send notification to, and receive notifications from, the presenter module 210. For example, the communication manager 265 of the audience module 250 may receive the notifications of new images and the images themselves, transmitted from the presenter's communication manager 230. When an image is received at the communication manager 265, the communication manager 265 may confirm receipt back to the presenter module 210, including the image's unique identifier, to keep the presenter module 210 apprised of which images have been received.

The display manager 270 may determine which images have been received and may determine which image to display at the audience module 250 at a given time. To that end, the display manager 270 may maintain an image cache, which may contain the various images received from the presenter module 210. With the image cache, each image may be associated with its unique identifier assigned at the presenter module 210. The display manager 270 may also have access to the image identifiers sent separately from the images themselves, so the display manager 270 may be aware when expected images have not been received.

The display manager 270 need not display an image as soon as it is received. Rather, the display manager 270 may continue to display its current image until receiving an update instruction from the presenter module 210. To determine when to send this update instruction, the presenter module 210 may follow a predetermined set of rules, which rules may be based on image receipts received from the communication managers 265 of the audience modules 250.

The presenter module 210 may receive indication from the presenter as to which image the presenter would like to display next as the active image for the presentation. In some exemplary embodiments, this indication may be implied. For example, the most recent captured image may be assumed to be the one the presenter wishes to display next. For another example, the presenter may explicitly indicate which image he or she would like to be the next active image.

As mentioned above, however, the audience modules 250 may continue to display the current active image until receiving an update instruction from the presenter module 210. This update instruction may be sent automatically by the presenter module 210 when a predetermine set of one or more conditions are met. The update instruction, when sent to the audience modules 250, may include not only an instruction to update the active image, but also a reference to the unique identifier of the image that the presenter module 210 determines the presenter desires to be the next active image.

Because the presenter module 210 may receive image receipt confirmations from the various audience modules 250, the presenter module 210 may be aware of which images have been received at each audience module 250. In some exemplary embodiments, the presenter module 210 may display to the presenter various statistics related to which images have been received by the various audience modules 250. The predetermined condition upon which the presenter module may send the update instruction to the audience module may be based on these statistics, regardless of whether the statistics are displayed. This predetermined condition may be, for example: a predetermined number or percentage of the audience modules 250 have confirmed receipt of the image desired to be the next active image; a specified audience module has confirmed receipt of the image desired to be the next active image; a predetermined number or percentage of audience modules 250 connected over specified network types have confirmed receipt of the image desired to be the next active image; or the presenter has manually indicated that it's time to update the active image.

When an update instruction and associated image identifier are received at an audience module 250, the display manager 270 of the audience module 250 may update the active image being displayed on the audience module 250 to match the image identified in the update instruction. Because the presenter module 210 may send the update to all audience modules 250 only after certain conditions related to receipt confirmation are met, and because the presenter module 210 may be aware of which audience modules 250 have confirmed receipt of the now-active image, the presenter module 210 may be aware of which audience modules 250 are displaying the active image after the update instruction is sent. In some embodiments, the audience modules 250 able to update the image as instructed will do so and then transmit a confirmation of the update back to the presenter module 210 for further confirmation. Based on this information received from the audience modules, the presentation module 210 may display to the presenter which images are being displayed by each of the various audience modules 250.

The presenter module 210 and the audience module 250, respectively, may keep the presenter and the audience informed as to the status of the presentation. The presenter module 210 may alert the presenter of issues related to the presentation at the various audience modules 250, as indicated by the heartbeats received at presenter connection manager 220, or as determined by other statistics collected, such as the time it takes for an audience module 250 to respond to various transmissions. The presenter module 210 may keep the presenter apprised of which audience modules 250 are not displaying the active image. The presenter may take action based on these alerts and information, such as by contacting the audience members that are using audience modules 250 with apparent issues. The audience module 250 may alert the audience of issues related to the presentation, as indicated by the heartbeats received at the audience connection manager 260, and when the audience is not displaying the presentation's active image.

It will be understood that alerts to the presenter and audience regarding the heartbeats, presentation statistics, or presentation issues can come in various forms, such as by way of notification, dialogs, or status updates. Additionally, the presentation system 200 or it users may provide various solutions to presentation issues if they arise. For example, and not by way of limitation, an audience module 250 may provide an “out of sync” status when a heartbeat is not received. In that case, the presentation system 200 may enable the audience to download the presentation and view it asynchronously. For another example, a presenter may receive a “slow image transmission” status from the presenter module 210 when a connected audience module 250 is receiving presentation images too slowly. In that case, the presenter may slow down the presentation or may instruct the corresponding audience to download the active image for asynchronous viewing.

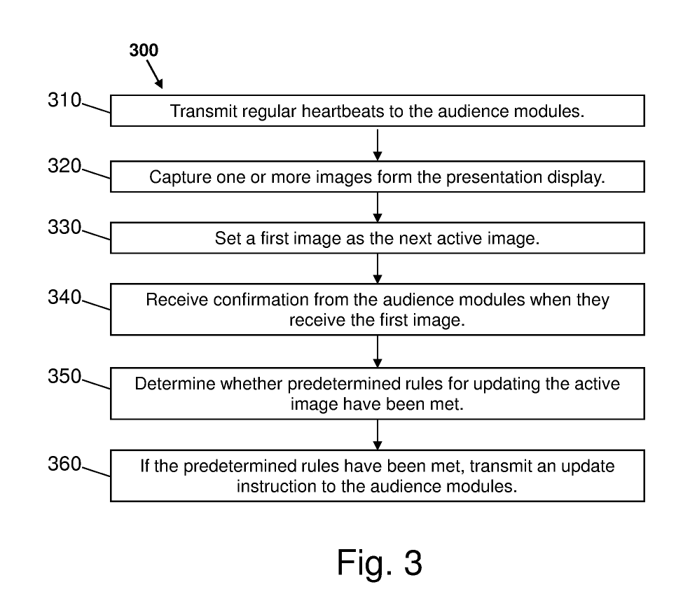

FIG. 3 is a flow diagram of a method 300 for providing a presentation, as seen from the presenter module 210, according to an exemplary embodiment of this disclosure. As shown, at block 310, the presenter module 210 may transmit regular heartbeats to the audience modules 250 with which it is connected. This may occur throughout the remainder of the method 300. At block 320, one or more images may be captured. At block 330, a first image may be deemed to be the next active image. At block 340, confirmation may be received from one or more of the audience modules 250 that the first image has been received. At block 350, it is determined whether the predetermined rules for updating the active image are met, based at least in part on the confirmations received. At block 360, after the rules are met, an update instruction may be transmitted to the audience modules 250.

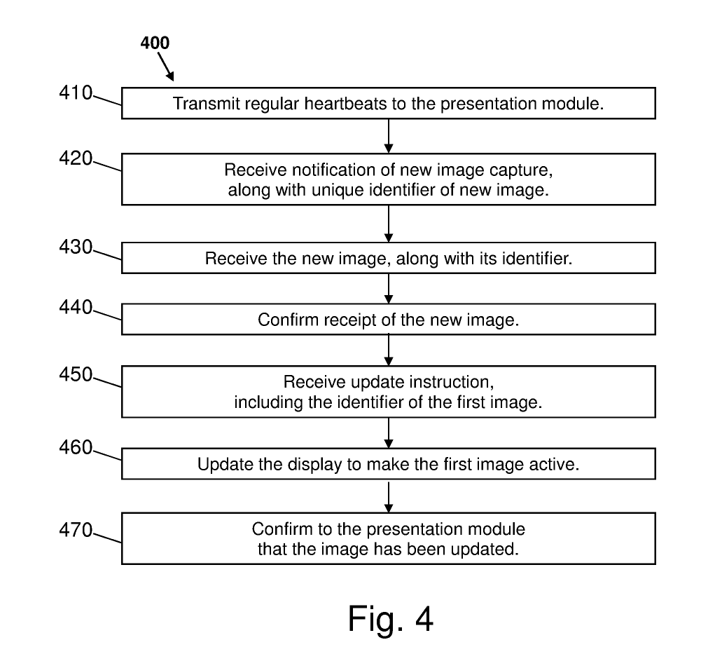

FIG. 4 is a flow diagram of a method 400 for receiving a presentation, as seen from the audience module 250, according to an exemplary embodiment of this disclosure. At block 410, the audience module may transmit regular heartbeats to the presenter module 210. This may occur throughout the remainder of the method 400. At block 420, a notification of a new image capture may be received, along with an identifier for the new image. At block 430, the image itself may be received, along with its identifier. At block 440, the audience module 250 may confirm receipt of the new image to the presenter module 210. At block 450, an update instruction may be received, indicating the identifier of the new image. At block 460, the current display may be updated to show the new image. At block 470, the audience module may confirm that the display has been updated.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

Further, as will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency (RF), etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1-6. (canceled)

7. A presentation system, comprising:
an image capturer configured to capture a plurality of images from a presentation and to associate each of the plurality of images with a unique identifier;
a communication manager configured to transmit to one or more remote audience modules a first image of the plurality of images and a first identifier associated with the first image; and
a display manager configured to identify the first image as a next active image for the presentation;
wherein the communication manager is further configured to receive indications from one or more of the audience modules that the next active image has been received; and
wherein the display manager is further configured to instruct the audience modules to update their displays from a current active image to the next active image, after the connection manager receives the indications.

8. The system of claim 7, the display manager being further configured to determine which of the audience modules are displaying the next active image, after instructing the audience modules to update their displays from the current active image to the next active image.

9. The system of claim 7, the communication manager being further configured to determine which of the audience modules have received the next active image, wherein instructing the audience modules to update their displays from the current active image to the next active image occurs after a predetermined set of rules has been met, and wherein the predetermined set of rules relate to which of the audience modules have received the next active image.

10. The system of claim 7, further comprising a connection manager configured to receive periodic heartbeats from a first audience module of the plurality of audience modules to indicate that a connection to the first audience module exists, the connection manager being further configured to output an alert when an expected heartbeat is not received from the first audience module.

11. The system of claim 7, wherein the communication manager is configured to transmit the first identifier in a first transmission and the first identifier along with the first image in a second transmission.

12-17. (canceled)

18. A system comprising:
a display manager configured to display an active image as part of a presentation; and
a communication manager configured to
receive, from a presenter module over a network, a plurality of images, each image being associated with a unique identifier; and
receive, after receiving the plurality of images, an instruction to update the active image, the instruction referencing a first unique identifier;
wherein the display manager is further configured to select a first image from the plurality of images based on the first image being identified by the first unique identifier, and to display the first image as the active image in response to the instruction.

19. The system of claim 18, the communication manager being further configured to receive a series of instructions referencing unique identifiers representing a first subset of the plurality of images, wherein the series of instructions excludes a second subset of the unique identifiers, and the display manager being further configured to display the first subset of the plurality of images as part of the presentation and exclude from the presentation the second subset of the plurality of images.

20. The system of claim 18, the communication manager being further configured, after receiving the plurality of images, to receive a second instruction to update the active image, the instruction referencing a second unique identifier, and to provide a notification that the presentation is not displaying the correct image if a second image represented by the second unique identifier is not among the plurality of images.

21. The system of claim 18, the display manager being further configured, after receiving the plurality of images, to continue displaying the active image until receiving an instruction to update the active image.

22. The system of claim 18, further comprising a connection manager configured to receive a series of periodic heartbeats from the presenter module to indicate that a connection to the presentation module exists, the connection manager being further configured to provide a notification if the series of periodic heartbeats ceases.
